(19) United States
(12) Patent Application Publication
(10) Pub. No.: US 2008/0305951 A1
(43) Pub. Date: Dec. 11, 2008

(54) Method for Incorporating a Functional Additive within a Porous Material

(76) Inventors: Jacobus Eversdijk, Den Bosch (NL); Cornelis Hermanus Rentrop, Eindhoven (NL); Michael Fritz Sailer, Pijnacker (NL); Rudolf Hartmut Cher, Mierlo (NL); Diana Benz, Buchel (DE)

Correspondence Address: NIXON & VANDERHYE, PC, 901 NORTH GLEBE ROAD, 11TH FLOOR, ARLINGTON, VA, 22203, US

(21) Appl. No.: 11/991,653

(22) PCT Filed: Sep. 11, 2006
(86) PCT No.: PCT/NL2006/000449

§ 371 Date: May 27, 2008

(30) Foreign Application Priority Data
Sep. 12, 2005 (EP) 05077087.4

(51) Int. Cl. B01J 20/12; B01J 20/00; B01J 20/32; B01J 20/10; C04B 38/08

(52) U.S. Cl. 502/410; 502/400; 502/407; 502/414; 501/80

(57) ABSTRACT

The invention relates a method for incorporating a functional additive within a porous material, which method comprises impregnating the porous material with a slurry of a nano-sized material that carries the functional additive, wherein in the slurry the weight ratio of the additive (A) and the nano-sized material (B) is in the range of from 0.01 to 1.0 (A/B). The invention further relates to a porous material obtainable by said method.

The present invention relates to a method for incorporating a functional additive within a porous material, and a porous material obtainable by said method.

It is well known that the properties of a wide variety of porous materials can be adjusted and improved by incorporating within said materials particular additives. Suitable examples include, for example, the tanning of leather, the impregnation of wood with a wood preservative or pigment/colorant, and the incorporation of catalytically active species within a ceramic carrier material.

A drawback of the known incorporating methods is that usually frequently a poor penetration depth of the additive is established, resulting in only a shell of additive on the outer surface of the porous material in question. Moreover, in such shell the additive is generally not uniformly distributed. Usually the distribution of the additive is in the form of a gradient.

For various reasons this can be highly undesirable. For example, in the case of outdoor wood application it is important for durability/maintenance reasons that the wood is deeply penetrated, if not entirely, with a wood preservative. A similar reasoning can be applied to, for instance, polymer materials that need to be reinforced or textiles, paper and catalyst particles.

Hence, there is need to develop a method which brings about an improved penetration, incorporation and distribution of additives within porous materials.

Surprisingly, it has now been found that this can be established by using a slurry of a nano-sized material that carries the additive.

Accordingly, the present invention relates to a method for incorporating a functional additive within a porous material, which method comprises impregnating the porous material with a slurry of a nano-sized material that carries the functional additive, wherein in the slurry the weight ratio of the additive (A) and the nano-sized material (B) is in the range of from 0.01 to 1.0 (A/B).

The method according to the present invention enables the deep and uniform penetration of functional additives into porous materials, making the materials obtained much more efficient for their particular purposes. Examples of improved properties of porous materials in which a functional additive in accordance with the present has been incorporated include fire resistance, moisture/water resistance, appearance/colour, durability, strength and dimensional stability.

In accordance with the method of the present invention the nano-sized material and the functional additive are impregnated into the porous material, i.e. that they will enter more easily the pores of the porous material.

In the context of the present invention, a nano-sized material is defined as being a material that comprises nano-sized particles that have at least in one direction an average length of less than 1 micro meter.

Suitably, the nano-sized particles to be used in accordance with the present invention has at least in one direction an average length of less than 1000 nm. Preferably, the nano-sized particles have at least in one direction an average length of less than 100 nm.

More preferably, the nano-sized particles will have at least in two directions have an average length of less than 1000 nm, even more preferably less than 100 nm.

In a very attractive embodiment of the present invention, the nano-sized particles will in all three directions have an average length of less than 1000 nm, more preferably of less than 100 nm.

Suitable examples of the nano-sized materials include natural or synthetic phyllosilicates such as smectites, halloycitse, illites, chlorites, vermicalites, sepiolites, silicates or hydrotalcites and polymeric colloids.

Preferably, the nano-sized material comprises a clay.

Suitably, the clay to be used in accordance with the present invention may be selected from the group consisting of water swellable phyllosilicates.

Preferably, the clay comprises montmorillonites, hydrotalcites, sepiolites or Laponites. In the method according to the present invention, the slurry suitably comprises such amounts of the nano-sized material and the functional additive that in the slurry the weight ratio of the additive (A) and the nano-sized material (B) is in the range of from 0.01 to 1.0 (A/B).

Preferably, in the slurry the weight ratio of the additive (A) and the nano-sized material (B) is in the range of from 0.01 to 0.20 (A/B), more preferably in the range of from 0.01 to 0.1 (A/B).

The high amount of the nano-sized material present in the slurry has the advantage that ions can be exchanged at the surface of the nano-sized material, compounds may be adsorbed on said surface, or compounds can be chemically coupled to said surface, thus increasing the functionality of the slurry.

The functional additive can be any additive known in the art to improve the properties of porous materials. Suitable examples include dyes, biocides, water-repellents, anti-oxidants, flame retarding chemicals, tanning agents, fragrances, flavouring additives, catalytically active species and UV-stabilizers, biological active substances, substances to improve strengths, substances to improve dimensional stability, hydrophobation substances, glues, and curable substances.

Preferably, the functional additive is a non-polymer additive, i.e. a functional additive other than a polymer.

Preferably, the functional additive comprises biocides, dyes or flame retarding chemicals, tanning agents or hydrophobating substances.

The slurry can be a water-based or a solvent-based slurry, depending on the nature of the porous material to be applied.

Suitable examples of solvents include ethanol, tetrahydrofuran, white spirit, toluene and dichloromethane.

Preferably, use is made of a water-based slurry.

Suitably, in the slurry the amount of nano-sized material is in the range of from 0.1 to 20 weight %, preferably in the range of from 0.1 to 10 weight %, based on total slurry.

Suitably, the porous material is impregnated with the slurry at a temperature in the range of from 10 to 160° C., preferably the temperature applied is in the range of from 10 to 80° C. The method according to the present invention can be carried out under application of an ambient pressure (dipping), reduced pressure (vacuum) and/or high pressure. If a high pressure is applied, the pressure will be applied up to 15 bar.

Suitably) the slurry is present in an amount in the range of from 0.01 to 60 weight %, preferably in the range of from 0.1 to 30 weight %, based on the total amount of solids in the slurry and porous material It will be. understood that the amount to be used will depend on the type of application and the porosity of the porous material to be used.

Suitably, the porous material is impregnated with the slurry for a period of time in the range of from 1 minute to 48 hours, preferably in the range of from 10 minutes to 20 hours.

Suitably, the method according to the present invention is carried out at a pH in the range of from 1 to 14, preferably in the range of from 3 to 12.

Suitably, the method according to the present invention is carried out at a pressure in the range of from 1 to 15 bar, preferably in the range of from 1 to 8 bar.

The porous material to be used in accordance with the present invention can be chosen from a wide variety of porous material. Suitable examples of porous materials include wood, textiles, paper, leather, ceramic materials, porous polymer materials, wood plastic composites other wood containing materials, lignocellulosic materials, or building materials such as bricks and concrete. Preferably, the porous material comprises wood, paper or leather.

The ceramic materials may comprise, for example, ceramic oxides that are used as a carrier material for any type of catalyst.

Polymer materials obtained in accordance with the present invention can, for example, be used for manufacturing (SLS) Selective Laser Sintering van polymer objects in the rapid prototyping and or rapid manufacturing. The objects can later be impregnated in order to improve fire resistance or the colour.

The present invention further relates to a porous material obtainable by the method according to the present invention. Such porous material displays unique properties in terms of depth of penetration and uniform distribution of the functional additive.

### EXAMPLES

### Example 1 (Comparative Example)

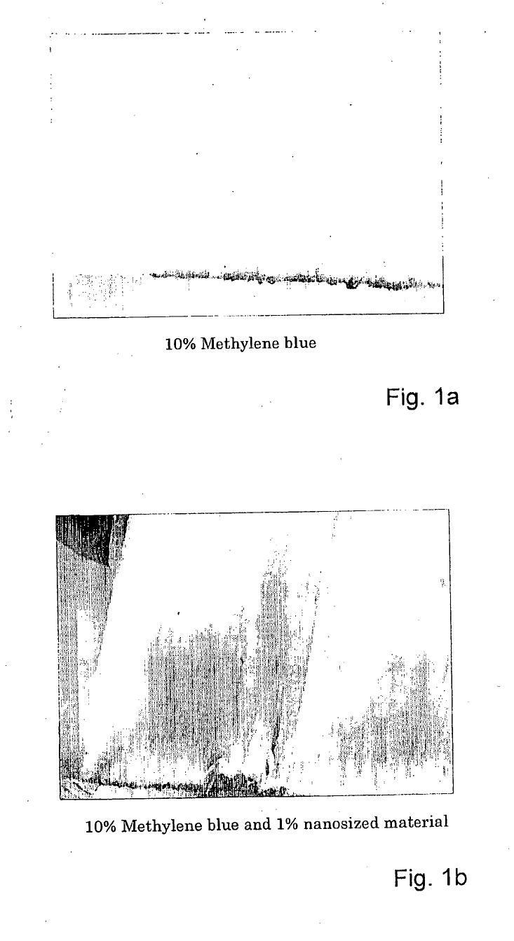

An Impregnation test was carried out with cutted wood sample of spruce having dimensions of 20×20×20 mm3. The sample were sealed on 5 edges sealed and the remaining edge was dipped over a period of 20 hours in 10% methylene blue dissolved in water at a temperature of 20° C., which methylene blue solution had a pH of 6 The result obtained is shown in FIG. 1a.

### Example 2 (According to the Invention)

An experiment was carried out in a similar way as Example, except that now nano-sized material was used in an amount of 1% weight, based on the total solution carrying methylene blue. The nano-sized material used was Laponite having 1 nm×25 nm×25 nm. The result thus obtained is shown in FIG. 1b.

From the results as shown in FIGS. 1a and 1b it will be clear that in the presence of the nano-sized material the methylene blue solution penetrated much further in the wood sample.

1. A method for incorporating a functional additive within a porous material, which method comprises impregnating the porous material with a slurry of a nano-sized material that carries the functional additive, wherein in the slurry the weight ratio of the additive (A) and the nano-sized material (B) is in the range of from 0.01 to 1.0 (A/B).

2. A method according to claim 1, wherein the nano-sized material comprises nano-sized particles that have at least in one direction an average length of smaller than 1000 nm.

3. A method according to claim 2, wherein the nano-sized particles have at least in one direction an average length of smaller than 100 nm.

4. A method according to claim 1, wherein the nano-sized material comprises a clay.

5. A method according to claim 3, wherein the clay is selected from the group consisting of natural or synthetically water swellable phyllosilicates and hydrotalcites.

6. A method according to claim 4, wherein the clay comprises montmorillonites, hydrotalcites, sepiolites or Laponites.

7. A method according to claim 1, wherein in the slurry the weight ratio of the additive (A) and the nano-sized material (B) is in the range of from 0.01 to 0.20 (A/B).

8. A method according to claim 1, wherein the slurry is a water-based slurry.

9. A method according to claim 1, wherein in the slurry the amount of nano-sized material is in the range of from 0.1% to 20%, based on total slurry.

10. A method according to claim 1, wherein the slurry is contacted with the porous material at a temperature in the range of from 10 to 160° C.

11. A method according to claim 1, wherein the functional additive is selected from the group consisting of dyes, boicides, water-repellents, anti-oxidants, flame retarding chemicals, tanning agents, fragrances, flavouring additives, catalytically active species, UV-stabilizers, biological active substances, substances to improve strengths, substances to improve dimensional stability, hydrophobation substances, glues and curable substances.

12. A method according to claim 1, wherein the functional additive is a non-polymer additive.

13. A method according to claim 1, wherein the porous material is selected from the group consisting of wood, textiles, paper, leather, ceramic materials, porous polymer materials, wood containing materials, lignocellulosic materials, and wood plastic components.

14. A method according to claim 13, wherein the porous material comprises a wood leather or other lignocellulosic materials.

15. A porous material obtainable by the method according to claim 1.
